(19) United States
(12) Patent Application Publication
(10) Pub. No.: US 2020/0189032 A1
(43) Pub. Date: Jun. 18, 2020

(54) Machining Robot for Machining Workpieces Using a Laser Beam, Comprising a Machining Laser Integrated into a Robot Arm

(71) Applicant: Robot Technology GmbH, Großostheim (DE)

(72) Inventor: Stefan Maier, Großostheim (DE)

(73) Assignees: Robot Technology GmbH, Großostheim (DE); Robot Technology GmbH, Großostheim (DE)

(21) Appl. No.: 16/500,434

(22) PCT Filed: Mar. 29, 2018
(86) PCT No.: PCT/DE2018/000081

§ 371 Date: Oct. 3, 2019

(30) Foreign Application Priority Data
Apr. 3, 2017 (DE) 10 2017 003 199.1

(51) Int. Cl. B23K 26/08; B23K 26/06; B23K 26/082; B23K 26/14; B23K 26/16

(52) U.S. Cl. CPC B23K 26/0884; B23K 26/0643; B23K 26/16; B23K 26/1462; B23K 26/082

(57) ABSTRACT

The application relates to a machining robot (1) for machining workpieces using a laser beam (2), in particular a machining robot (1) having six axes, wherein the laser beam (2) is to be directed, especially by deflecting means, substantially along a longitudinal axis (3) of the machining robot (1) via an articulated coupling means (14) into an inlet (4) into a central machining robot shaft (5) and to a machining robot head (6) comprising a laser machining tool, in particular a jet nozzle means (19) around an output region (8) of the laser beam (2); the machining laser (9) for generating the laser beam (2) is integrated into a machining robot arm (10) which is part of the central machining robot shaft (5) and which essentially comprises a carbon housing (11), in particular consists of a carbon housing (11).

### TECHNICAL FIELD

The invention is related to a machining robot for machining workpieces with a laser beam and to a method for machining a workpiece using a machining robot.

### BACKGROUND

It is well known that machining robots are equipped with machining axes and movable arms that guide a laser beam to the front of a machining head. These elements are very stable, but at the same time require a large fixture and high weight when a reliable, quickly accessible large machining area is required.

### SUMMARY

The task of the present disclosure is to provide a simple and safe machining robot that at the same time avoids the disadvantages of the state of the art.

The problem is solved by a machining robot for machining workpieces using a laser beam, in particular a machining robot having six axes, wherein the laser beam is to be directed, especially by deflecting means, substantially along a longitudinal axis of the machining robot via an articulated coupling means into an inlet into a central machining robot axis and to a machining robot head comprising a laser machining tool, in particular a nozzle means around an output region of the laser beam, whereby the machining laser for generating the laser beam is integrated into a machining robot arm of the central machining robot axis, which essentially comprises a carbon housing, in particular consists of a carbon housing.

In the case of the laser machining robot, in particular a complete upper housing made of carbon with corresponding connection points made of aluminum. The laser machining robot comprises in particular six axes. The complete upper housing corresponds advantageously to an outer housing of the arm.

The carbon housing comprises advantageously a light and stable carbon fiber composition.

In the arrangement, for example, the movements of a known robot can be used and at the same time the laser beam function can be integrated and a large working range can be achieved.

A laser machining tool, in particular a scanner, in this laser machining robot can be arranged after a sixth axis in the area of the fifth axis, usually a rotary axis. This allows the tool length of the machining robot to be significantly shortened towards the front, which has considerable speed and accuracy advantages during reorientation.

The laser housing can be connected laterally to a corresponding rotary axis. Due to the machining robot variant with the internal laser beam feedthrough in the fourth and sixth axis, the beam guidance can be realized with little effort.

It is advantageous if the machining robot arm with the machining laser is integrated into a third or fourth machining robot axis.

It is advantageous if the inlet of the coupling means is arranged on one side of the central machining robot axis in such a way that the coupling means experiences only a slight movement due to the movement of the machining robot.

It is advantageous if the inlet of the coupling means is located close to the beginning of the machining robot axis, especially in an elbow area of an articulated arm robot.

It is advantageous if a mirror/a mirror pair is provided at the laser situated end of the coupling means and a mirror/a mirror pair at the axial end of the coupling means.

It is advantageous if the machining laser has a laser power between about 60 W and about 300 W, in particular that the machining laser is a CO2 laser.

It is advantageous if a scanner, in particular a high-performance scanner, is used in the head area of the machining robot.

It is advantageous if the machining robot has a weight of approximately 300 kg, whereby the laser in particular has a weight of approximately 32 kg and/or that the machining robot has a large ratio of working area length to footprint, in particular approximately 3 to 1.

The present disclosure thus enables a very good ratio of working range to stand area, especially with light robots of approximately 300 kg.

It is advantageous if a funnel means is provided for the suction in the front area of the machining robot head. The funnel allows suction in the front area. This means that the funnel can be carried along during the robot movement and a simpler fixture design can be achieved.

It is advantageous if an exchange device for the nozzle means with a passing system is provided at the machining robot head and/or the nozzle means is arranged rotatably.

It is advantageous to implement a nozzle means changing device with a passing system, whereby the nozzle means is held in a receptacle and indexed, for example, by at least one, in particular two, pneumatic cylinders. Indexing can be done once from the right and once from the left. The machining robot can then pick up the station from the left, for example, and deposit it from the right. This means that the machining robot only has to pass through once, as the nozzle medium is picked up by a spring-loaded ball centering system, which saves cycle time.

A rotation of an air nozzle can also be arranged advantageously. Depending on the process, this allows a more targeted exhaust air removal to be achieved by the air jet.

The problem is also solved by a method for machining a workpiece using a machining robot for machining workpieces with a laser beam, in particular a machining robot having six axis, wherein the laser beam is directed in particular by deflection means substantially along a longitudinal axis of the machining robot via an articulated coupling means into an inlet into a central machining robot axis up to a machining robot head comprising a laser machining tool, in particular with a nozzle means around an output region of the laser beam, the machining laser for generating the laser beam being integrated in a machining robot arm of the central machining robot axis, which substantially comprises a carbon housing, in particular consisting thereof, in particular using one of the devices as disclosed.

### BRIEF DESCRIPTION OF THE DRAWINGS

FIG. 1 shows a machining robot in perspective view.

FIG. 2 shows a machining robot in perspective view in partial representation.

FIG. 3 shows a machining robot in perspective view in partial representation.

### DETAILED DESCRIPTION

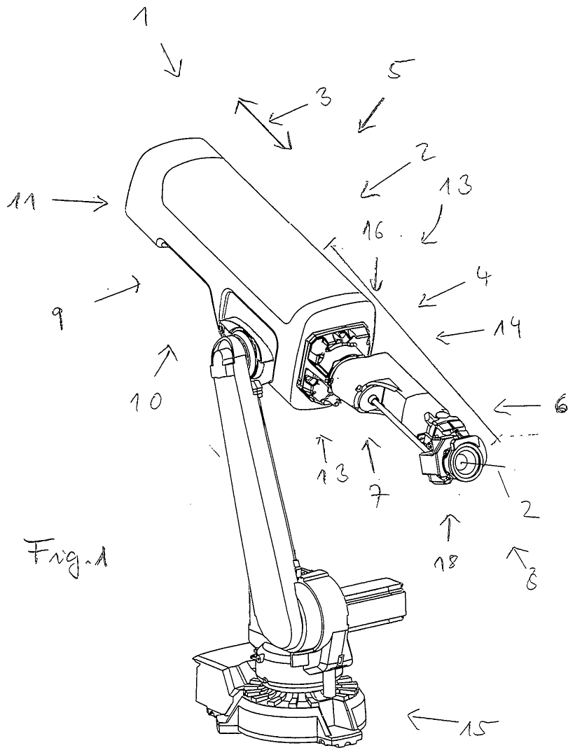

FIG. 1 shows a machining robot 1 in perspective view, for machining workpieces with a laser beam, in particular a six-axis machining robot, the laser beam 2 in particular via deflection means substantially along a longitudinal axis 3 of the machining robot 1 via an attached coupling means 14 into an inlet 4 into a central machining robot axis 5 up to a machining robot head 6, in particular with a nozzle means 19 around an output region 8 of the laser beam 2, the machining laser 9 for generating the laser beam 2 being integrated in a machining robot arm 10 of the central machining robot axis 5, which substantially comprises a carbon housing 11, in particular consisting thereof. The machining robot head area 6 of the machining laser 9 is equipped with a scanner 18, especially a high-performance scanner.

The inlet 4 of the coupling means 14 on one side 7 of the central machining robot axis 5 is arranged in such a way that the coupling means 14 experiences only a slight movement due to the movement of the machining robot arm 10.

A ratio of working length 16 to stand area 15 is very large, which leads to good accessibility of differentiated and distant workpiece structures.

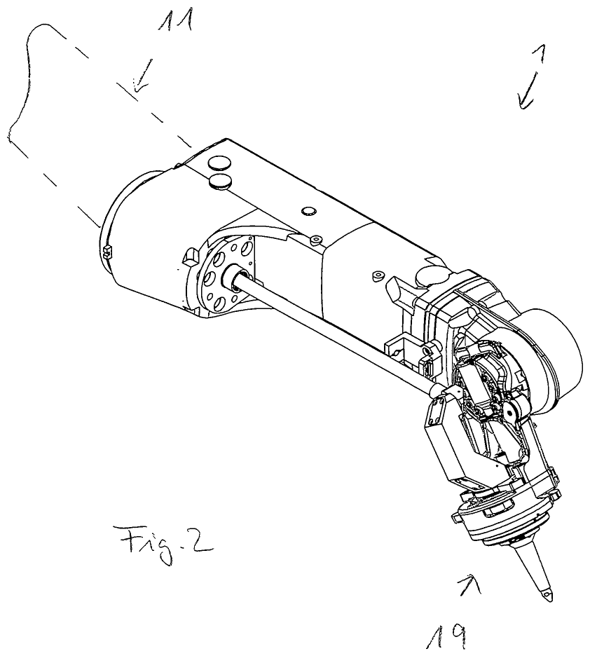

FIG. 2 shows a machining robot 1 in perspective view in partial representation, wherein an exchange device (not represented) for the nozzle means 19 with a passing through system can be provided at the machining robot head 6 and/or the nozzle means 19 is rotatably arranged.

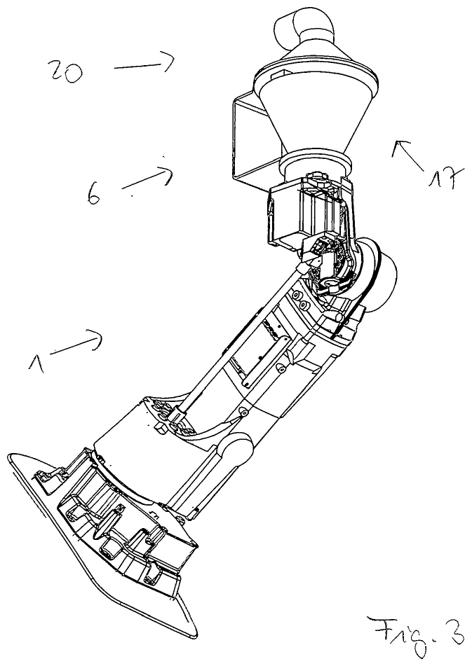

FIG. 3 shows a machining robot 1 in perspective view in partial representation, wherein a funnel means 17 is provided for the extraction in the front area 20 of the machining robot head 6.

### REFERENCE SIGNS

1 machining robot
2 laser beam
3 longitudinal axis
4 inlet
5 central machining robot axis
6 machining robot head
7 side
8 output region
9 machining laser
10 machining robot arm
11 carbon housing
13 laser situated end
14 coupling means
15 standing area
16 working length
17 funnel means
18 scanner
19 nozzle means
20 front region

1.-10. (canceled)

11. A machining robot (1) for machining workpieces using a laser beam (2),
wherein the laser beam (2) is directed, via deflectors,
substantially along a longitudinal axis (3) of the machining robot (1)
via an articulated coupling (14) into an inlet (4) into a central machining robot axis (5) and to a machining robot head (6) comprising a laser machining tool, and
wherein a machining laser (9) for generating the laser beam (2) is integrated in a machining robot arm (10) of the central machining robot axis (5), which essentially comprises a carbon housing (11).

12. The machining robot according to claim 11, wherein the machining robot has six axes.

13. The machining robot according to claim 11, wherein the machining robot head (6) comprises a nozzle (19) around an output region (8) of the laser beam (2).

14. The machining robot according to claim 11, wherein the machining robot arm (10) with the machining laser (9) is integrated into a third or fourth machining robot axis (5).

15. The machining robot according to claim 11, wherein the inlet (4) of the coupling (3) is arranged on one side (7) of the central machining robot axis (5) such that the coupling (14) experiences only a slight movement due to the movement of the machining robot arm (10).

16. The machining robot according to claim 11, wherein the inlet (4) of the coupling (14) is arranged close to a beginning of the central machining robot axis (5).

17. The machining robot according to claim 16, wherein the inlet (4) of the coupling (14) is arranged in an elbow region of an articulated arm robot.

18. The machining robot according to claim 11, wherein a mirror or a mirror pair is provided at a laser situated end (13) of the coupling (14) and a further mirror or a further mirror pair is provided at an axial end (11) of the coupling (14).

19. The machining robot according to claim 11, wherein the machining laser (9) has a laser power between about 60 W and about 300 W.

20. The machining robot according to claim 11, wherein the machining laser (9) is a CO2 laser.

21. The machining robot according to claim 11, further comprising a scanner (18) arranged in a region of the machining robot head (6) of the machining robot (9).

22. The machining robot according to claim 11, wherein an extraction funnel (17) is provided in a front region (20) of the machining robot head (6).

23. The machining robot according to claim 13, wherein a changing device for the nozzle (19) with a traversing system is provided on the machining robot head (6).

24. The machining robot according to claim 13, wherein the nozzle (19) is arranged rotatably.

25. The machining robot according to claim 13 having a weight of 300 kg.

26. The machining robot according to claim 13, wherein the machining laser (9) has a weight of 32 kg.

27. The machining robot according to claim 13 having a ratio of working area to standing area of 3 to 1.

28. A method for machining a workpiece using a machining robot (1) for machining workpieces with a laser beam, comprising:
directing the laser beam (2) by defectors substantially along a longitudinal axis (3) of the machining robot (1) via an articulated coupling (14) into an inlet (4) into a central machining robot axis (5) up to a machining robot head (6) comprising a laser machining tool,
wherein a machining laser (9) for generating the laser beam (2) is integrated in a machining robot arm (10) of the central machining robot axis (5), which substantially comprises a carbon housing (11).
